(19) United States
(12) Patent Application Publication
(10) Pub. No.: US 2026/0303484 A1
(43) Pub. Date: Oct. 1, 2026

(54) UPLINK HYBRID AUTOMATIC REPEAT REQUEST (HARQ) MODE RESTRICTION FOR A RADIO BEARER OF APPLICATION LAYER MEASUREMENT REPORTING

(71) Applicant: Apple Inc., Cupertino, CA (US)

(72) Inventors: Ping-Heng Kuo, London (GB); Fangli Xu, Beijing (CN); Yuqin Chen, Beijing (CN); Haijing Hu, Los Gatos, CA (US)

(21) Appl. No.: 18/996,474

(22) PCT Filed: Jul. 26, 2022
(86) PCT No.: PCT/CN2022/107822

§ 371 Date: Jan. 17, 2025

(51) Int. Cl. H04L 41/5067; H04L 1/1867; H04W 24/10

(52) U.S. Cl. CPC H04L 41/5067; H04L 1/188; H04W 24/10

(57) ABSTRACT

A user equipment (UE) includes a transceiver and a processor. The processor is configured to receive, via the transceiver, a configuration for a radio bearer dedicated to reporting of at least one application layer measurements or quality of experience (QoE) measurements to a network. The processor is configured to receive, via the transceiver, a configuration for a logical channel (LCH) corresponding to the radio bearer, and a configuration of an uplink (UL) hybrid automatic repeat request (HARQ) mode restriction corresponding to the LCH. The processor is configured to report, via the LCH and based on the HARQ mode restriction corresponding to the LCH, the at least one application layer measurements or QoE measurements to the network. The base station may be in a non-terrestrial network (NTN), and the radio bearer may be a signaling radio bearer 4(SRB 4).

### TECHNICAL FIELD

This application relates generally to wireless communication systems, including methods and systems for setting an uplink hybrid automatic repeat request (HARQ) mode restriction for a radio bearer of uplink transmission of an application layer measurement report (or a quality of experience (QoE) report).

### BACKGROUND

Wireless mobile communication technology uses various standards and protocols to transmit data between a base station and a wireless communication device. Wireless communication system standards and protocols can include, for example, 3rd Generation Partnership Project (3GPP) long term evolution (LTE) (e.g., 4G), 3GPP new radio (NR) (e.g., 5G), and IEEE 802.11 standard for wireless local area networks (WLAN) (commonly known to industry groups as Wi-Fi®).

As contemplated by the 3GPP, different wireless communication systems standards and protocols can use various radio access networks (RANs) for communicating between a base station of the RAN (which may also sometimes be referred to generally as a RAN node, a network node, or simply a node) and a wireless communication device known as a user equipment (UE). 3GPP RANs can include, for example, global system for mobile communications (GSM), enhanced data rates for GSM evolution (EDGE) RAN (GERAN), Universal Terrestrial Radio Access Network (UTRAN), Evolved Universal Terrestrial Radio Access Network (E-UTRAN), and/or Next-Generation Radio Access Network (NG-RAN).

Each RAN may use one or more radio access technologies (RATs) to perform communication between the base station and the UE. For example, the GERAN implements GSM and/or EDGE RAT, the UTRAN implements universal mobile telecommunication system (UMTS) RAT or other 3GPP RAT, the E-UTRAN implements LTE RAT (sometimes simply referred to as LTE), and NG-RAN implements NR RAT (sometimes referred to herein as 5G RAT, 5G NR RAT, or simply NR). In some deployments, the E-UTRAN may also implement NR RAT. In some deployments, NG-RAN may also implement LTE RAT.

A base station used by a RAN may correspond to that RAN. One example of an E-UTRAN base station is an Evolved Universal Terrestrial Radio Access Network (E-UTRAN) Node B (also commonly denoted as evolved Node B, enhanced Node B, eNodeB, or eNB). One example of an NG-RAN base station is a next generation Node B (also sometimes referred to as a g Node B or gNB).

A RAN provides its communication services with external entities through its connection to a core network (CN). For example, E-UTRAN may utilize an Evolved Packet Core (EPC), while NG-RAN may utilize a 5G Core Network (5GC).

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 shows an example wireless communication system, according to embodiments described herein.

FIG. 2 illustrates an example flow-chart of operations that may be performed by a UE, according to embodiments described herein.

FIG. 3 illustrates another example flow-chart of operations that may be performed by a UE, according to embodiments described herein.

FIG. 4 illustrates an example flow-chart of operations that may be performed by a base station, according to embodiments described herein.

FIG. 5 illustrates an example architecture of a wireless communication system, according to embodiments described herein.

FIG. 6 illustrates a system for performing signaling between a wireless device and a network device, according to embodiments described herein.

### DETAILED DESCRIPTION

In the present disclosure, various embodiments are related to systems and methods for setting an uplink HARQ mode restriction for a radio bearer of uplink transmission of an application layer measurement report, which may be referred to hereafter as a QoE report. In particular, the embodiments described herein are related to configuring a UE for a HARQ mode restriction for transmission of the QoE report using a signaling radio bearer 4 (SRB4) to a base station. The base station may be in a terrestrial network or a non-terrestrial network (NTN), and the QoE report may be visible to a radio access network (RAN) (e.g., RAN-visible) or not visible to the RAN (e.g., RAN-invisible). A RAN-visible QoE report may be utilized by a RAN for optimization of the RAN. A RAN-invisible QoE report may be utilized by a network for various purposes, including but not limited to, optimization of the core network or the RAN, collection of statistical information for analysis, and so on. The network, as described herein, may also include a core network, such as a 5G core network, and so on.

Based on recent studies in 3GPP, a HARQ process may be configured to operate in one of the two possible modes—HARQ mode A and HARQ mode B. In the HARQ mode A, a UE starts a drx-HARQ-RTT-TimerUL for the corresponding HARQ process in the first symbol after the end of the first transmission (within a bundle) of the corresponding PUSCH transmission. The HARQ mode A is a legacy HARQ operation. In the HARQ mode B, the UE does not start drx-HARQ-RTT-TimerUL for the corresponding HARQ process, and will also not start drx-RetransmissionTimerUL for the corresponding HARQ process.

In some embodiments, the HARQ mode B is preferrable to cope with long round trip time (RTT) when a UE is in communication with a base station in an NTN. The UE does not need to wait for retransmission grant, even though blind retransmission may have been scheduled by the base station.

In some embodiments, a base station may configure a logical channel (LCH) mapping restriction regarding a HARQ mode for an LCH. As described herein, the HARQ mode for the LCH may be pre-configured to be one of the HARQ mode A or the HARQ mode B. By way of a non-limiting example, the HARQ mode B may be pre-configured for a radio bearer without a high reliability target. Further, the LCH mapping restriction regarding the HARQ mode may be configured using an allowedHARQ-mode included in a logicalChannelConfig as specified 3^{rd} Generation Partnership Project (3GPP) Technical Specification (TS) 38.331 Rel 17. The allowedHARQ-mode included in the logicalChannelConfig indicates an allowed HARQ mode of a HARQ process mapped to a logical channel, and applied to SRB1, SRB2, and SRB3. As described herein, in some embodiments, the allowedHARQ-mode filed of the logicalChannelConfig may be used to indicate a HARQ mode for a HARQ process using SRB4.

Also based on recent studies in 3GPP, an application layer measurement, which is also known as and referred to herein as a QoE, a QoE reporting framework is defined. A UE may be configured to perform application layer measurement(s) corresponding to an application executing on the UE. The UE may receive a measurement report from the application and generate an application layer measurement report or a QoE report to a network. In this disclosure, an application layer measurement may also mean a QoE measurement, and vice versa, and an application layer measurement report may also mean a QoE report, and vice versa. Further, the QoE report may be visible to a radio access network (RAN), for example, to a base station, and may be referred to herein as a RAN-visible QoE report. Alternatively, the QoE report may not be visible to a RAN, and may be referred to herein as a RAN-invisible QoE report.

A QoE report may be sent to the network using a SRB4. The SRB4 may be configured as defined in 3GPP Technical Specification (TS) 38.331. Accordingly, in some embodiments, the SRB4 is for a radio resource control (RRC) message including QoE report information. The SRB4 may use a dedicated control channel (DCCH) logical channel. By way of a non-limiting example, the SRB4 may be configured by the core network after access stratum (AS) security activation.

In some embodiments, the QoE report may be sent using the SRB4, and a reliability level of the SRB4 may be configured by the network. For example, the reliability level of the SRB4 may be configured by the network based on whether the network needs reliable QoE information for network optimization, statistical data collection, and/or data analysis, and so on.

As described above, the reliability of an SRB may be related to a HARQ mode, and currently the HARQ mode may be specified only for the SRB1, the SRB2, and the SRB3. Accordingly, various embodiments described in the present disclosure provide a solution for configuring or setting the reliability mode for the SRB4, which may be used to send the QoE report to the network. By way of a non-limiting example, the QoE report may be generated and/or applicable in an NTN scenario as well.

Reference will now be made in detail to representative embodiments/aspects illustrated in the accompanying drawings. The following description is not intended to limit the embodiments to one preferred embodiment. On the contrary, it is intended to cover alternatives, combinations, modifications, and equivalents as can be included within the spirit and scope of the described embodiments as defined by the appended claims.

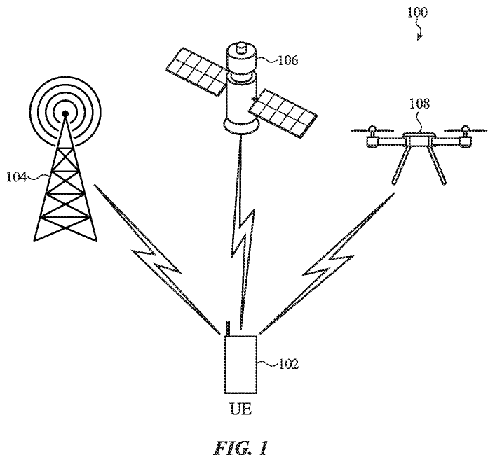

FIG. 1 shows an example wireless communication system, according to embodiments described herein. As shown in FIG. 1, a wireless communication system 100 may include base stations 104, 106, and/or 108, and a UE 102. In some embodiments, the base stations 104, 106, and/or 108 may be an eNb, an eNodeB, a gNodeB, or an access point (AP) in a radio access network (RAN) and may support one or more radio access technologies, such as 4G, 5G, 5G new radio (5G NR), and so on. Further, the RAN may be a terrestrial network (TN) or an NTN. For example, the base stations 106 and 108 are in an NTN, and the base station 104 is in a TN. The base station in NTN may be on a satellite in the earth's orbit, or may be on a drone or an unmanned aerial vehicle (UAV). The UE 102 may be a phone, a smart phone, a tablet, a smartwatch, an Internet-of-Things (IoT), and so on.

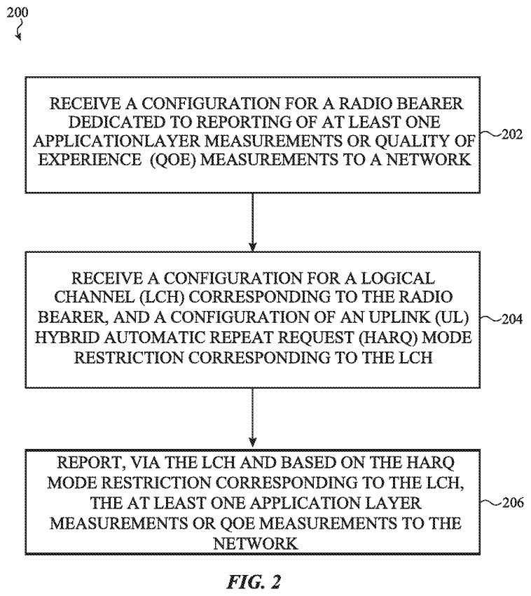

FIG. 2 illustrates an example flow-chart of operations that may be performed by a UE, according to embodiments described herein. In some embodiments, a HARQ mode for a HARQ process corresponding to transmission of a QoE report using an SRB4 on an LCH may be configured by a base station. Accordingly, as shown in a flow-chart 200, at 202, a UE may receive, via a transceiver of the UE, a configuration corresponding to a radio bearer dedicated to reporting of at least one application layer measurements or QoE measurements to a network. By way of a non-limiting example, the radio bearer may be SRB4. By way of a non-limiting example, the configuration corresponding to the radio bearer for reporting the QoE measurements to the network may be received by the UE from a base station and/or from a network via the base station. The configuration corresponding to the radio bearer may indicate the UE may generate a QoE report or an application layer measurement report and transmit using radio bearer. The configuration corresponding to the radio bearer may also indicate whether the UE may need to segment the QoE report in case a size of the QoE report exceeds a threshold byte size, for example, 9000 bytes.

At 204, the UE may receive a configuration for a logical channel (LCH) corresponding to the radio bearer (e.g., the SRB4) . Additionally, or alternatively, the UE may also receive a configuration of an uplink (UL) HARQ mode restriction corresponding to the LCH. The LCH may be used and/or assigned for transmission of the QoE report. The UL HARQ mode restriction for the LCH may be set to a HARQ mode A or a HARQ mode B. The HARQ mode A and the HARQ mode B are described above in the present disclosure, and hence those details are not repeated for brevity. By way of a non-limiting example, the configuration for the LCH and/or the configuration for the UL HARQ mode restriction corresponding to the LCH may be received by the UE from the base station and/or from a core network via the base station.

At 206, the UE may report, via the LCH and based on the HARQ mode restriction corresponding to the LCH as received in the configuration at 204, the at least one application layer measurements or QoE measurements to the network. The UE may perform a HARQ process based on the UL HARQ mode restriction as set or configured for the LCH channel for transmission of the QoE report. In other words, the UE may map SRB4 data (e.g., the QoE report) to a radio resource with a HARQ process of a configured UL HARQ mode. As described herein, the QoE report and/or the QoE measurements may correspond to an application requiring a reliability that is at least above a particular or predetermined threshold value, or below the particular or predetermined threshold value. By way of a non-limiting example, for application layer measurements or QoE measurements corresponding to an application or an application target requiring a reliability at least above the particular or predetermined threshold value, the HARQ mode restriction may be set to the HARQ mode A; otherwise, the HARQ mode restriction may be set to the HARQ mode B.

In some embodiments, a HARQ mode restriction or a specific HARQ mode for an LCH for transmission of a QoE report using an SRB4 may not be specified in the allowedHARQ-mode field of the logicalChannelConfig described above, or any other configuration that may be used to set the HARQ model restriction for an LCH for transmission of the QoE report using the SRB4.

In FIG. 2, a HARQ mode restriction is set at the UE based on a configuration received from a network and/or a base station. The HARQ mode restriction in the configuration may be set by the network and/or the base station according, for example, an RTT, a desired reliability for an application target, or an application, and so on.

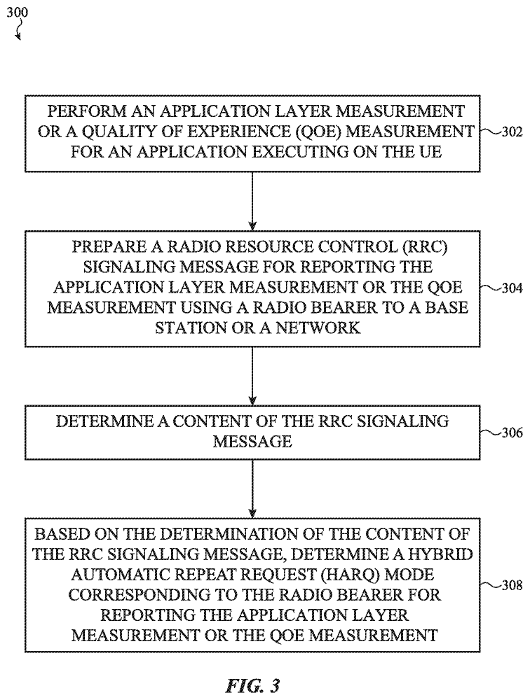

Alternatively, or additionally, a HARQ mode restriction for an LCH for transmission of a QoE report using an SRB4 may be selected or determined by a UE based on a content of an RRC message (e.g., the SRB4) carrying the QoE report information, as described in detail using FIG. 3 below.

FIG. 3 illustrates another example flow-chart of operations that may be performed by a UE, according to embodiments described herein. As shown in a flow-chart 300, at 302, a UE may perform an application layer measurement or a QoE measurement for an application executing on the UE. The UE may perform the QoE measurement periodically or aperiodically (e.g., on-demand). The QoE measurement may be related to a bit rate (e.g., transport capacity), latency, continuity, data loss, and so on. The QoE measurement may thus collect measurement data corresponding to an application layer of a UE protocol stack.

At 304, the UE may prepare or build an RRC signaling message for reporting the QoE measurement to a network and/or a base station. The RRC signaling message may be sent on radio bearer (e.g., SRB4) , as described herein in accordance with some embodiments. Accordingly, the QoE measurement report may be transmitted to the network and/or the base station using the SRB4. The QoE report may be a RAN-visible QoE report and/or a RAN-invisible QoE report, as described herein.

At 306, the UE may determine a content of the RRC signaling message (e.g., the QoE report to be conveyed by the radio bearer, which may include the SRB4) . By way of a non-limiting example, the UE may determine that the content includes an identity of the application layer measurement or the QoE measurement, a type of the application layer measurement or the QoE measurement. The UE may also determine whether the QoE measurement corresponds to a RAN-visible QoE report or a RAN-visible QoE measurement, or a RAN-invisible QoE report or a RAN-invisible QoE measurement. In some embodiments, the UE may determine whether the content of the SRB4 is based on, or associated with, a quality of service (QOS) flow that is mapped to a data radio bearer for a communication service of the application associated with the application layer measurement or the QoE measurement.

At 308, in accordance with the content of the QoE report to be conveyed on SRB4 as determined at 306, a HARQ mode may be determined or selected by the UE for a HARQ process associated with an LCH used for transmission of the QoE report to the base station and/or the network using the SRB4. By way of a non-limiting example, the UE may determine the HARQ mode based on the identity of the application layer measurement or the QoE measurement, or the type of the application layer measurement or the QoE measurement, as determined by the UE at 306. The HARQ mode to be selected by the UE corresponding to the identity of the application layer measurement or the QoE measurement, or the type of the application layer measurement or the QoE measurement, may be preconfigured at the UE, for example, by the base station and/or the core network.

In some embodiments, and by way of a non-limiting example, for the RAN-visible QoE measurement or the RAN-visible QoE report, or the RAN-invisible QoE measurement or the RAN-invisible QoE report, the UE may select the HARQ mode A for a HARQ process associated with an LCH used for transmission of the QoE report using the SRB4.

In some embodiments, the UE may select the HARQ mode B for the RAN-invisible QoE measurement or the RAN-invisible QoE report for a HARQ process associated with an LCH used for transmission of the QoE report using an SRB4.

In some embodiments, the HARQ mode may be determined based on the QoS flow determined at 306 above. For a QoS flow associated with requiring a reliability above a predetermined reliability threshold, the HARQ mode A may be selected; otherwise, the HARQ mode B may be selected.

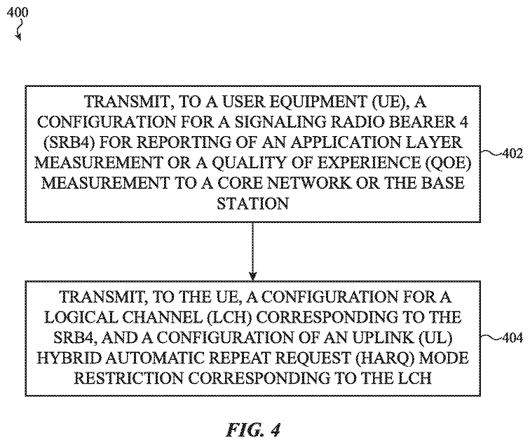

FIG. 4 illustrates an example flow-chart of operations that may be performed by a base station, according to embodiments described herein. As shown in a flow-chart 400, at 402, a base station may transmit, to a UE and via a transceiver of the base station, a configuration corresponding to an SRB4 for reporting of QoE measurements to a network. The configuration corresponding to the SRB4 may indicate whether the UE may generate a QoE report or an application layer measurement report and transmit using an SRB4. The configuration corresponding to the SRB4 may also indicate whether the UE may need to segment the QoE report in case a size of the QoE report exceeds a threshold byte size, for example, 9000 bytes.

At 404, the base station may transmit to the UE a configuration for a logical channel (LCH). Additionally, or alternatively, the base station may also transmit a configuration of an uplink (UL) HARQ mode restriction corresponding to the LCH. The LCH may be used and/or assigned for transmission of the QoE report. The UL HARQ mode restriction for the LCH may be set to a HARQ mode A or a HARQ mode B. The HARQ mode A and the HARQ mode B are described above in the present disclosure, and hence those details are not repeated for brevity. In some embodiments, no HARQ mode may be specified by the base station, and the UE may determine a HARQ mode, as described herein in accordance with some embodiments. The base station may determine and include in the configuration which HARQ mode to use based on a reliability associated with an application executing on the UE of the corresponding application layer measurement or the QoE measurement, an identity of the application layer measurement or the QoE measurement, and/or a type of the application layer measurement or the QoE measurement.

Embodiments contemplated herein include an apparatus having means to perform one or more elements of the method 200, 300, or 400. In the context of method 200, or 300, this apparatus may be, for example, an apparatus of a UE (such as a wireless device 602 that is a UE, as described herein). In the context of method 400, this apparatus may be, for example, an apparatus of a base station (such as a network device 620 that is a base station, as described herein).

Embodiments contemplated herein include one or more non-transitory computer-readable media storing instructions to cause an electronic device, upon execution of the instructions by one or more processors of the electronic device, to perform one or more elements of the method 200, 300, or 400. In the context of method 200, or 300, this non-transitory computer-readable media may be, for example, a memory of a UE (such as a memory 606 of a wireless device 602 that is a UE, as described herein). In the context of method 400, this non-transitory computer-readable media may be, for example, a memory of a base station (such as a memory 624 of a network device 620 that is a base station, as described herein).

Embodiments contemplated herein include an apparatus having logic, modules, or circuitry to perform one or more elements of the method 200, 300, or 400. In the context of method 200, or 300, this apparatus may be, for example, an apparatus of a UE (such as a wireless device 602 that is a UE, as described herein). In the context of method 400, this apparatus may be, for example, an apparatus of a base station (such as a network device 620 that is a base station, as described herein).

Embodiments contemplated herein include an apparatus having one or more processors and one or more computer-readable media, using or storing instructions that, when executed by the one or more processors, cause the one or more processors to perform one or more elements of the method 200, 300, or 400. In the context of method 200, or 300, this apparatus may be, for example, an apparatus of a UE (such as a wireless device 602 that is a UE, as described herein). In the context of the method 600, this apparatus may be, for example, an apparatus of a base station (such as a network device 620 that is a base station, as described herein).

Embodiments contemplated herein include a signal as described in or related to one or more elements of the method 200, 300, or 400.

Embodiments contemplated herein include a computer program or computer program product having instructions, wherein execution of the program by a processor causes the processor to carry out one or more elements of the method 200, 300, or 400. In the context of method 200, or 300, the processor may be a processor of a UE (such as a processor(s) 604 of a wireless device 602 that is a UE, as described herein), and the instructions may be, for example, located in the processor and/or on a memory of the UE (such as a memory 606 of a wireless device 602 that is a UE, as described herein). In the context of method 400, the processor may be a processor of a base station (such as a processor(s) 622 of a network device 620 that is a base station, as described herein), and the instructions may be, for example, located in the processor and/or on a memory of the base station (such as a memory 624 of a network device 620 that is a base station, as described herein).

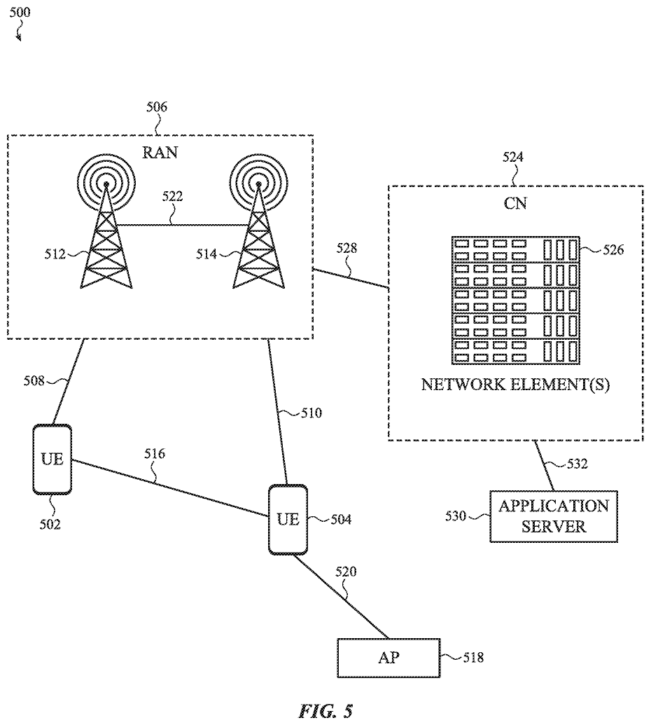

FIG. 5 illustrates an example architecture of a wireless communication system, according to embodiments described herein. The following description is provided for an example wireless communication system 500 that operates in conjunction with the LTE system standards and/or 5G or NR system standards as provided by 3GPP technical specifications.

As shown by FIG. 5, the wireless communication system 500 includes UE 502 and UE 504 (although any number of UEs may be used). In this example, the UE 502 and the UE 504 are illustrated as smartphones (e.g., handheld touchscreen mobile computing devices connectable to one or more cellular networks), but may also comprise any mobile or non-mobile computing device configured for wireless communication.

The UE 502 and UE 504 may be configured to communicatively couple with a RAN 506. In embodiments, the RAN 506 may be NG-RAN, E-UTRAN, etc. The UE 502 and UE 504 utilize connections (or channels) (shown as connection 508 and connection 510, respectively) with the RAN 506, each of which comprises a physical communications interface. The RAN 506 can include one or more base stations, such as base station 512 and base station 514, that enable the connection 508 and connection 510.

In this example, the connection 508 and connection 510 are air interfaces to enable such communicative coupling, and may be consistent with RAT(s) used by the RAN 506, such as, for example, an LTE and/or NR.

In some embodiments, the UE 502 and UE 504 may also directly exchange communication data via a sidelink interface 516. The UE 504 is shown to be configured to access an access point (shown as AP 518) via connection 520. By way of example, the connection 520 can comprise a local wireless connection, such as a connection consistent with any IEEE 802.11 protocol, wherein the AP 518 may comprise a Wi-Fi® router. In this example, the AP 518 may be connected to another network (for example, the Internet) without going through a CN 524.

In embodiments, the UE 502 and UE 504 can be configured to communicate using orthogonal frequency division multiplexing (OFDM) communication signals with each other or with the base station 512 and/or the base station 514 over a multicarrier communication channel in accordance with various communication techniques, such as, but not limited to, an orthogonal frequency division multiple access (OFDMA) communication technique (e.g., for downlink communications) or a single carrier frequency division multiple access (SC-FDMA) communication technique (e.g., for uplink and ProSe or sidelink communications), although the scope of the embodiments is not limited in this respect. The OFDM signals can comprise a plurality of orthogonal subcarriers.

In some embodiments, all or parts of the base station 512 or base station 514 may be implemented as one or more software entities running on server computers as part of a virtual network. In addition, or in other embodiments, the base station 512 or base station 514 may be configured to communicate with one another via interface 522. In embodiments where the wireless communication system 500 is an LTE system (e.g., when the CN 524 is an EPC), the interface 522 may be an X2 interface. The X2 interface may be defined between two or more base stations (e.g., two or more eNBs and the like) that connect to an EPC, and/or between two eNBs connecting to the EPC. In embodiments where the wireless communication system 500 is an NR system (e.g., when CN 524 is a 5GC), the interface 522 may be an Xn interface. The Xn interface is defined between two or more base stations (e.g., two or more gNBs and the like) that connect to 5GC, between a base station 512 (e.g., a gNB) connecting to 5GC and an eNB, and/or between two eNBs connecting to 5GC (e.g., CN 524).

The RAN 506 is shown to be communicatively coupled to the CN 524. The CN 524 may comprise one or more network elements 526, which are configured to offer various data and telecommunications services to customers/subscribers (e.g., users of UE 502 and UE 504) who are connected to the CN 524 via the RAN 506. The components of the CN 524 may be implemented in one physical device or separate physical devices including components to read and execute instructions from a machine-readable or computer-readable medium (e.g., a non-transitory machine-readable storage medium).

In embodiments, the CN 524 may be an EPC, and the RAN 506 may be connected with the CN 524 via an S1 interface 528. In embodiments, the S1 interface 528 may be split into two parts, an S1 user plane (S1-U) interface, which carries traffic data between the base station 512 or base station 514 and a serving gateway (S-GW), and the S1-MME interface, which is a signaling interface between the base station 512 or base station 514 and mobility management entities (MMEs).

In embodiments, the CN 524 may be a 5GC, and the RAN 506 may be connected with the CN 524 via an NG interface 528. In embodiments, the NG interface 528 may be split into two parts, an NG user plane (NG-U) interface, which carries traffic data between the base station 512 or base station 514 and a user plane function (UPF), and the S1 control plane (NG-C) interface, which is a signaling interface between the base station 512 or base station 514 and access and mobility management functions (AMFs).

Generally, an application server 530 may be an element offering applications that use internet protocol (IP) bearer resources with the CN 524 (e.g., packet switched data services). The application server 530 can also be configured to support one or more communication services (e.g., VoIP sessions, group communication sessions, etc.) for the UE 502 and UE 504 via the CN 524. The application server 530 may communicate with the CN 524 through an IP communications interface 532.

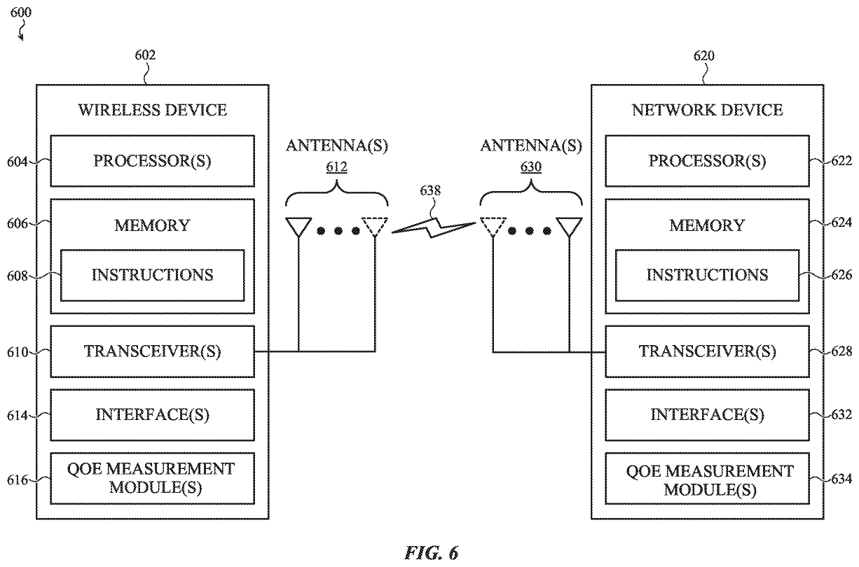

FIG. 6 illustrates a system 600 for performing signaling 638 between a wireless device 602 and a network device 620, according to embodiments described herein. The system 600 may be a portion of a wireless communication system as herein described. The wireless device 602 may be, for example, a UE of a wireless communication system. The network device 620 may be, for example, a base station (e.g., an eNB or a gNB) of a wireless communication system.

The wireless device 602 may include one or more processor(s) 604. The processor(s) 604 may execute instructions such that various operations of the wireless device 602 are performed, as described herein. The processor(s) 604 may include one or more baseband processors implemented using, for example, a central processing unit (CPU), a digital signal processor (DSP), an application specific integrated circuit (ASIC), a controller, a field programmable gate array (FPGA) device, another hardware device, a firmware device, or any combination thereof configured to perform the operations described herein.

The wireless device 602 may include a memory 606. The memory 606 may be a non-transitory computer-readable storage medium that stores instructions 608 (which may include, for example, the instructions being executed by the processor(s) 604). The instructions 608 may also be referred to as program code or a computer program. The memory 606 may also store data used by, and results computed by, the processor(s) 604.

The wireless device 602 may include one or more transceiver(s) 610 that may include radio frequency (RF) transmitter and/or receiver circuitry that use the antenna(s) 612 of the wireless device 602 to facilitate signaling (e.g., the signaling 638) to and/or from the wireless device 602 with other devices (e.g., the network device 620) according to corresponding RATs.

The wireless device 602 may include one or more antenna(s) 612 (e.g., one, two, four, or more). For embodiments with multiple antenna(s) 612, the wireless device 602 may leverage the spatial diversity of such multiple antenna(s) 612 to send and/or receive multiple different data streams on the same time and frequency resources. This behavior may be referred to as, for example, multiple input multiple output (MIMO) behavior (referring to the multiple antennas used at each of a transmitting device and a receiving device that enable this aspect). MIMO transmissions by the wireless device 602 may be accomplished according to precoding (or digital beamforming) that is applied at the wireless device 602 that multiplexes the data streams across the antenna(s) 612 according to known or assumed channel characteristics such that each data stream is received with an appropriate signal strength relative to other streams and at a desired location in the spatial domain (e.g., the location of a receiver associated with that data stream). Some embodiments may use single user MIMO (SU-MIMO) methods (where the data streams are all directed to a single receiver) and/or multi user MIMO (MU-MIMO) methods (where individual data streams may be directed to individual (different) receivers in different locations in the spatial domain).

In some embodiments having multiple antennas, the wireless device 602 may implement analog beamforming techniques, whereby phases of the signals sent by the antenna(s) 612 are relatively adjusted such that the (joint) transmission of the antenna(s) 612 can be directed (this is sometimes referred to as beam steering).

The wireless device 602 may include one or more interface(s) 614. The interface(s) 614 may be used to provide input to or output from the wireless device 602. For example, a wireless device 602 that is a UE may include interface(s) 614 such as microphones, speakers, a touchscreen, buttons, and the like in order to allow for input and/or output to the UE by a user of the UE. Other interfaces of such a UE may be made up of transmitters, receivers, and other circuitry (e.g., other than the transceiver(s) 610/antenna(s) 612 already described) that allow for communication between the UE and other devices and may operate according to known protocols (e.g., Wi-Fi®, Bluetooth®, and the like).

The wireless device 602 may include a QoE measurement module 616. The QoE measurement module 616 may be implemented via hardware, software, or combinations thereof. For example, the QoE measurement module 616 may be implemented as a processor, circuit, and/or instructions 608 stored in the memory 606 and executed by the processor(s) 604. In some examples, the QoE measurement module 616 may be integrated within the processor(s) 604 and/or the transceiver(s) 610. For example, the QoE measurement module 616 may be implemented by a combination of software components (e.g., executed by a DSP or a general processor) and hardware components (e.g., logic gates and circuitry) within the processor(s) 604 or the transceiver(s) 610.

The QoE measurement module 616 may be used for various aspects of the present disclosure, for example, aspects of FIGS. 2-4, from the UE perspective.

The network device 620 may include one or more processor(s) 622. The processor(s) 622 may execute instructions such that various operations of the network device 620 are performed, as described herein. The processor(s) 622 may include one or more baseband processors implemented using, for example, a CPU, a DSP, an ASIC, a controller, an FPGA device, another hardware device, a firmware device, or any combination thereof configured to perform the operations described herein.

The network device 620 may include a memory 624. The memory 624 may be a non-transitory computer-readable storage medium that stores instructions 626 (which may include, for example, the instructions being executed by the processor(s) 622). The instructions 626 may also be referred to as program code or a computer program. The memory 624 may also store data used by, and results computed by, the processor(s) 622.

The network device 620 may include one or more transceiver(s) 628 that may include RF transmitter and/or receiver circuitry that use the antenna(s) 630 of the network device 620 to facilitate signaling (e.g., the signaling 638) to and/or from the network device 620 with other devices (e.g., the wireless device 602) according to corresponding RATs.

The network device 620 may include one or more antenna(s) 630 (e.g., one, two, four, or more). In embodiments having multiple antenna(s) 630, the network device 620 may perform MIMO, digital beamforming, analog beamforming, beam steering, etc., as has been described.

The network device 620 may include one or more interface(s) 632. The interface(s) 632 may be used to provide input to or output from the network device 620. For example, a network device 620 that is a base station may include interface(s) 632 made up of transmitters, receivers, and other circuitry (e.g., other than the transceiver(s) 628/antenna(s) 630 already described) that enables the base station to communicate with other equipment in a core network, and/or that enables the base station to communicate with external networks, computers, databases, and the like for purposes of operations, administration, and maintenance of the base station or other equipment operably connected thereto.

The network device 620 may include a QoE measurement module 634. The QoE measurement module 634 may be implemented via hardware, software, or combinations thereof. For example, the QoE measurement module 634 may be implemented as a processor, circuit, and/or instructions 626 stored in the memory 624 and executed by the processor(s) 622. In some examples, the QoE measurement module 634 may be integrated within the processor(s) 622 and/or the transceiver(s) 628. For example, the QoE measurement module 634 may be implemented by a combination of software components (e.g., executed by a DSP or a general processor) and hardware components (e.g., logic gates and circuitry) within the processor(s) 622 or the transceiver(s) 628.

The QoE measurement module 634 may be used for various aspects of the present disclosure, for example, aspects of FIGS. 2-4, from a base station perspective.

For one or more embodiments, at least one of the components set forth in one or more of the preceding figures may be configured to perform one or more operations, techniques, processes, and/or methods as set forth herein. For example, a baseband processor as described herein in connection with one or more of the preceding figures may be configured to operate in accordance with one or more of the examples set forth herein. For another example, circuitry associated with a UE, base station, network element, etc. as described above in connection with one or more of the preceding figures may be configured to operate in accordance with one or more of the examples set forth herein.

Any of the above described embodiments may be combined with any other embodiment (or combination of embodiments), unless explicitly stated otherwise. The foregoing description of one or more implementations provides illustration and description, but is not intended to be exhaustive or to limit the scope of embodiments to the precise form described. Modifications and variations are possible in light of the above teachings or may be acquired from practice of various embodiments.

Embodiments and implementations of the systems and methods described herein may include various operations, which may be embodied in machine-executable instructions to be executed by a computer system. A computer system may include one or more general-purpose or special-purpose computers (or other electronic devices). The computer system may include hardware components that include specific logic for performing the operations or may include a combination of hardware, software, and/or firmware.

The systems described herein pertain to specific embodiments but are provided as examples. These embodiments can be combined into single systems, partially combined into other systems, split into multiple systems or divided or combined in other ways. In addition, it is contemplated that parameters, attributes, aspects, etc. of one embodiment can be used in another embodiment. The parameters, attributes, aspects, etc. are merely described in one or more embodiments for clarity, and it is recognized that the parameters, attributes, aspects, etc. can be combined with or substituted for parameters, attributes, aspects, etc. of another embodiment unless specifically disclaimed herein.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Although the foregoing has been described in some detail for purposes of clarity, it will be apparent that changes and modifications may be made without departing from the principles thereof. It should be noted that there are many alternative ways of implementing both the processes and apparatuses described herein. Accordingly, the present embodiments are to be considered illustrative and not restrictive, and the description is not to be limited to the details given herein, but may be modified within the scope and equivalents of the appended claims.

1. A user equipment (UE), comprising:
a transceiver; and
a processor configured to:
receive, via the transceiver, a configuration for a radio bearerdedicated to reporting of at least one application layer measurements or quality of experience (QoE) measurements to a network;
receive, via the transceiver, a configuration for a logical channel (LCH) corresponding to the radio bearer, and a configuration of an uplink (UL) hybrid automatic repeat request (HARQ) mode restriction corresponding to the LCH; and
report, via the LCH and based on the HARQ mode restriction corresponding to the LCH, the at least one application layer measurements or quality of experience (QoE) measurements to the network.

2. The UE of claim 1, wherein the base station is in a non-terrestrial network (NTN).

3. The UE of claim 1, wherein:
the UL HARQ mode restriction corresponds to HARQ mode A; and
the processor is configured to start a drx-HARQ-RTT-TimerUL timer for the HARQ process in a first symbol after an end of a first transmission of a physical uplink shared channel (PUSCH) of the application layer measurements or the quality of experience (QoE) measurements.

4. The UE of claim 1, wherein the radio bearer dedicated to reporting of the at least application layer measurements of the QoE measurements to the network is a signaling radio bearer 4 (SRB4) .

5. The UE of claim 1, wherein:
the UL HARQ mode restriction corresponds to HARQ mode B; and
the processor is configured to refrain from starting a drx-HARQ-RTT-TimerUL timer for the HARQ process after an end of a first transmission of a physical uplink shared channel (PUSCH) of the application layer measurements or the quality of experience (QoE) measurements.

6. The UE of claim 5, wherein the processor is configured to refrain from starting a drx-Retransmission TimeUL timer for the HARQ process.

7. The UE of claim 1, wherein the configuration of the UL HARQ mode restriction corresponding to the LCH indicates there is no HARQ mode restriction associated with the LCH.

8. A user equipment (UE), comprising:
a transceiver; and
a processor configured to:
perform an application layer measurement or a quality of experience (QoE) measurement for an application executing on the UE;
prepare a radio resource control (RRC) signaling message for reporting the application layer measurement or the QoE measurement, via the transceiver, using a radio bearer to a base station or a network;
determine a content of the RRC signaling message; and
based on the determination of the content of the RRC signaling message, determine a hybrid automatic repeat request (HARQ) mode corresponding to the radio bearer for reporting the application layer measurement or the QoE measurement.

9. The UE of claim 8, wherein the content of the RRC signaling message comprises an identity of the application layer measurement or the QoE measurement or a type of the application layer measurement or the QoE measurement.

10. The UE of claim 9, wherein the HARQ mode corresponding to the radio bearer for reporting the application layer measurement or the QoE measurement is preconfigured at the UE by the base station or the network corresponding to the identity of the application layer measurement or the QoE measurement, or the type of the application layer measurement or the QoE measurement.

11. The UE of claim 8, wherein:
the content of the RRC signaling message comprises the application layer measurement or the QoE measurement visible to a radio access network (RAN);
the determined HARQ mode corresponds to HARQ mode A; and
the processor is configured to start a drx-HARQ-RTT-TimerUL timer for a HARQ process in a first symbol after an end of a first transmission of a physical uplink shared channel (PUSCH) conveying at least one of the application layer measurement or the QoE measurement using the radio bearer.

12. The UE of claim 8, wherein:
the content of the RRC signaling message comprises the application layer measurement or the QoE measurement not visible to a radio access network (RAN);
the determined HARQ mode corresponds to HARQ mode A; and
the processor is configured to start a drx-HARQ-RTT-TimerUL timer for a HARQ process in a first symbol after ending of a first transmission of a physical uplink shared channel (PUSCH) conveying at least one of the application layer measurement or the QoE measurement.

13. The UE of claim 8, wherein:
the content of the RRC signaling message comprises the application layer measurement or the QoE measurement not visible to a radio access network (RAN);
the determined HARQ mode corresponds to HARQ mode B; and
the processor is configured to refrain from starting a drx-HARQ-RTT-TimerUL timer for a HARQ process after an end of a first transmission of a physical uplink shared channel (PUSCH) conveying at least one of the application layer measurement or the QoE measurement.

14. The UE of claim 13, wherein the processor is configured to refrain from starting a drx-Retransmission TimeUL timer for the HARQ process.

15. The UE of claim 8, wherein:
the processor is configured to,
determine the content of the RRC signaling message based on a quality of service (QoS) flow mapped to a data radio bearer for a communication service of the application associated with the application layer measurement or the QoE measurement; and
determine the HARQ mode based on the QoS flow of the application associated with the application layer measurement or the QoE measurement being reported using the radio bearer.

16. The UE of claim 8, wherein the base station is in a non-terrestrial network (NTN).

17. The UE of claim 8, wherein the radio bearer is a signaling radio bearer 4 (SRB4)

18. A base station, comprising:
a transceiver; and
a processor configured to:
transmit, to a user equipment (UE) and via the transceiver, a configuration for a signaling radio bearer 4 (SRB4) for reporting of an application layer measurement or a quality of experience (QoE) measurement to a core network or the base station; and
transmit, to the UE and via the transceiver, a configuration for a logical channel (LCH) corresponding to the SRB4, and a configuration of an uplink (UL) hybrid automatic repeat request (HARQ) mode restriction corresponding to the LCH.

19. The base station of claim 18, wherein:
the UL HARQ mode restriction corresponds to HARQ mode A, HARQ mode B, or none; and
the UL HARQ mode restriction is determined based on a reliability associated with an application executing on the UE of the corresponding application layer measurement or the QoE measurement.

20. The base station of claim 18, wherein:
the UL HARQ mode restriction corresponds to an identity of the application layer measurement or the QoE measurement or a type of the application layer measurement or the QoE measurement.
